(19) United States
(12) Patent Application Publication
(10) Pub. No.: US 2003/0202799 A1
(43) Pub. Date: Oct. 30, 2003

(54) Optical channel monitor using an angle-tuned fabry-perot optical filter

(76) Inventors: Dennis Chi Zhou, Cupertino, CA (US); Shou-Jong Sheih, Saratoga, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/136,036

(22) Filed: Apr. 29, 2002

(51) Int. Cl. H04B 10/02

(52) U.S. Cl. 398/177

(57) ABSTRACT

A monitor apparatus is configured to monitor optical performance in an optical fiber or an optical network. A tap is coupled to the optical fiber or optical network, and a signal input fiber. An angle-tuned solid Fabry-Perot etalon filter member is coupled to the tap. The Fabry-Perot etalon filter member includes an angle tuned solid Fabry-Perot etalon for the signal input fiber, and a calibration etalon for a reference input fiber. The Fabry-Perot etalon is associated with a first portion of a substrate, and the calibration etalon is associated with a second portion of the substrate. A first detector is positioned to receive a signal wavelength that travels through the angle tuned solid Fabry-Perot etalon filter. A second detector is positioned to receive a single wavelength reference that travels through the calibration etalon. Rotation of the angle-tuned solid Fabry-Perot etalon filter member, about a longitudinal axis of the substrate, provides optical signal measurement over wavelength, and a real time calibration by in response to a relationship of an angle of the angle-tuned solid Fabry-Perot etalon filter member and a transmission order of the reference calibration etalon.

### BACKGROUND

1. Field of the Invention

The present invention relates generally to optical signal monitoring, and more particularly to optical signal monitoring that uses an angle-tuned solid Fabry-Perot etalon filter.

2. Description of the Related Art

In optical telecommunication networks, it is very important to monitor the channel information, such as channel wavelengths, channel power and signal noise ration. The information about theses parameters can be used to adjust the power of add-channels, or to adjust the gain shape of amplifiers, such as EDFAs.

Various technologies have been invented to build optical channel monitors, such as optical grating combined with detector arrays, and tunable filters based on Fabry-Perot interferometer. The advantages of tunable filters as channel monitors are compact size, high resolution, continuous scanning and so on. Until now tunability is achieved in most tunable Fabry-Perot filters by changing the cavity length of the etalons, such as in U.S. Pat. Nos. 6,275,324, 6,341,039, 6,351,577, 5,212,746, 5,251,275. In the prior arts, the Fabry-Perot etalon cavity is either made by optical fibers or by Micro-Electrical-Mechanical System(MEMS). The requirement for the geometric linearity of the movement along the moving axis is critical to keep the nature of the Fabry-Perot etalon same during the scan, which is extremely difficult for moving parts, which is one of the main reason of low yield and high cost of this kind of products.

Another approach is to achieve tenability by rotating the planar cavity etalon, as in the articles Tunable Three Dimensional Solid-Fabry-Perot Etalons Fabricated by Surface-Micromachining, IEEE Photonics Technology Letters Vol.8, No.1, 1996; Angle-Tuned Fabry-Perot Etalon Filter Having Gaussian Transmittance Curves, IEEE Photonics Technology Letters, Vol.12, No.9, 2000; and Angle-Tuned Etalon Filters for Optical Channel Selection in High Density Wavelength Division Multiplexed Systems, Journal of Lightwave Technology, Vol.7, No.4, 1989. All of the above articles dealt with the application for channel selection and didn't provide enough resolution for channel monitoring purpose.

U.S. Pat. No. 5,361,155 (the “'155 Patent”) also describes a tunable filter for channel selection between an input fiber and an output fiber. Because of the axial displacement of the input beam due to the rotation of the etalon, the output fiber sees more loss when the rotation angle increases. A compensation plate is provided to bring the beam back to the normal position on the output fiber. However, the tunable filter of the '155 Patent is useful for optical mux/demux and not as a scanning optical monitor.

All the existing devices have difficulties with calibration if they are used for tunable filters.

There is a need for an improved a tunable filter for channel selection. There is a further need for a low cost angle-tuned Fabry-Perot etalon filter to monitor the optical performance in optical fibers and/or optical networks, including channel wavelength, channel power, and signal noise ratio.

### SUMMARY OF THE INVENTION

Accordingly, an object of the present invention is to provide an improved tunable filter for channel selection.

Another object of the present invention is to provide an angle-tuned Fabry-Perot etalon filter, and its method of use, to monitor the optical performance in optical fiber or optical networks, including channel wavelength, channel power, and signal noise ratio.

Yet another object of the present invention is to provide a fast scan, angle-tuned Fabry-Perot etalon filter for monitoring optical performance in optical fiber or optical networks.

A further object of the present invention is to provide angle-tuned Fabry-Perot etalon filter for monitoring optical performance in optical fiber or optical networks that has real-time in-line calibration and achieves high measurement accuracy.

A further object of the present invention is to provide angle-tuned Fabry-Perot etalon filter for monitoring optical performance in optical fiber or optical networks that has improved resolution.

Another object of the present invention is to provide angle-tuned a Fabry-Perot etalon filter for monitoring optical performance in optical fiber or optical networks that has reduced cost.

These and other objects of the present invention are achieved in a monitor apparatus configured to monitor optical performance in an optical fiber or an optical network. A tap is coupled to the optical fiber or optical network, and a signal input fiber. An angle-tuned solid Fabry-Perot etalon filter member is coupled to the tap. The Fabry-Perot etalon filter member includes an angle tuned solid Fabry-Perot etalon for the signal input fiber, and a calibration etalon for a reference input fiber. The Fabry-Perot etalon is associated with a first portion of a substrate, and the calibration etalon is associated with a second portion of the substrate. A first detector is positioned to receive a signal wavelength that travels through the angle tuned solid Fabry-Perot etalon filter. A second detector is positioned to receive a single wavelength reference that travels through the calibration etalon. Rotation of the angle-tuned solid Fabry-Perot etalon filter member, about a longitudinal axis of the substrate, provides optical signal measurement over wavelength, and a real time calibration by in response to a relationship of an angle of the angle-tuned solid Fabry-Perot etalon filter member and a transmission order of the reference calibration etalon.

In another embodiment of the present invention, a monitor apparatus is configured to monitor optical performance in an optical fiber or an optical network. A tap is coupled to the optical fiber or optical network, and a signal input fiber. An angle-tuned solid Fabry-Perot etalon filter member is coupled to the tap. The Fabry-Perot etalon filter includes an angle tuned solid Fabry-Perot etalon coupled to the signal input fiber and an input collimator, and a calibration etalon coupled to a reference input fiber and a reference input collimator. The Fabry-Perot etalon is associated with a first portion of a substrate, and the calibration etalon is associated with a second portion of the substrate. A first detector is positioned to receive a signal wavelength that travels through the angle tuned solid Fabry-Perot etalon filter. Rotation of the angle-tuned solid Fabry-Perot etalon filter member, about a longitudinal axis of the substrate, provides a real time calibration by in response to a relationship of an angle of the angle-tuned solid Fabry-Perot etalon member and a transmission order of the reference calibration etalon. A total reflection mirror is provided that produces a reflected signal beam from the input signal. The reflecting signal travels back through the angle-tuned solid Fabry-Perot etalon filter member. The angle tuned solid Fabry-Perot etalon filter member is positioned between the tap and the total reflection mirror. A circulator is coupled to the tap and the an angle-tuned solid Fabry-Perot etalon filter member. The circulator is positioned to receive the reflected signal beam. A second detector is positioned to receive at least a portion of the filtered signal beam.

### BRIEF DESCRIPTION OF THE DRAWINGS

FIG. 1 is a schematic diagram of one embodiment of an angle-tuned solid Fabry-Perot etalon monitor of the present invention.

FIG. 2 is a perspective of one embodiment an angle-tuned solid Fabry-Perot etalon monitor of the present invention.

FIG. 3 illustrates the relationship between rotation angle, transmission wavelength and angle sensitivity of the FIG. 1 embodiment.

FIG. 4 is a schematic illustrating passing of a beam through the Fabry-Perot etalon of FIG. 1.

FIG. 5 is a graph that illustrates the relationship of rotation angle and the transmission order of the reference etalon for a reference wavelength at 1540 nm.

FIG. 6 is a schematic diagram of one embodiment of a thermal single-wavelength reference source that can be used with the FIG. 1 embodiment.

FIG. 7 is a schematic diagram of an angle-tuned solid Fabry-Perot etalon monitor of the present invention that has a double-pass angle-tuned Fabry-Perot etalon.

### DETAILED DESCRIPTION OF PREFERRED EMBODIMENT

In various embodiments, the present invention provides an apparatus, and its methods of use directed generally to optical signal monitoring. In one embodiment, an angle-tuned solid Fabry-Perot etalon is provided and used for optical signal monitoring that uses in optical fiber, optical telecommunication networks and the like including but not limited to applications where spectral information is needed, such as scientific instrumentation, chemical, medical and biological analysis.

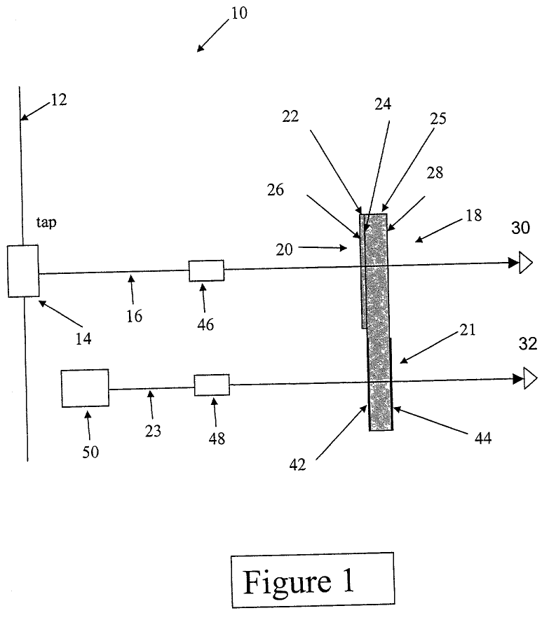

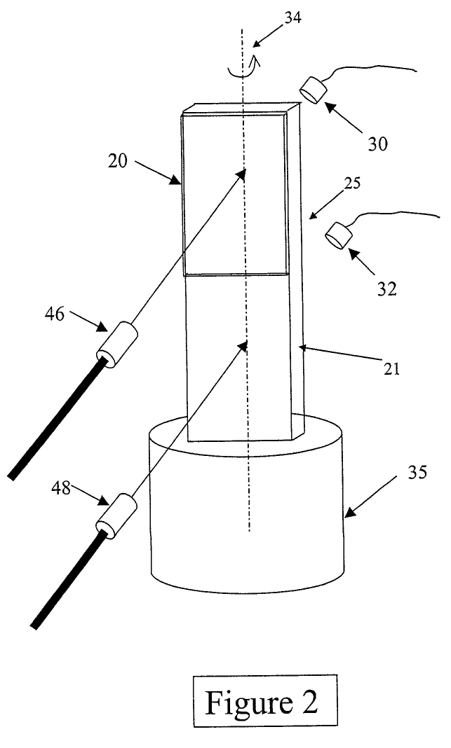

Referring now to FIGS. 1 and 2, one embodiment of a monitor apparatus 10 of the present invention, is configured to monitor optical performance in an optical fiber or an optical network (collectively 12). As illustrated in FIGS. 1 and 2, a tap 14 is coupled to the optical fiber or optical network 12, and a signal input fiber 16. An angle-tuned solid Fabry-Perot etalon filter member (generally denoted as 18) is coupled to tap 15.

Fabry-Perot etalon filter member 18 includes an angle tuned solid Fabry-Perot etalon 20 that is coupled to signal input fiber 16 through a input collimator 46, and a calibration etalon 21 coupled to a reference input fiber 23 through reference input collimator 48. Fabry-Perot etalon 20 is associated with a first portion of a substrate 25. Calibration etalon 21 is associated with a second portion of substrate 25 (FIG. 2). A first detector 30 is positioned to receive a signal wavelength that travels through angle tuned solid Fabry-Perot etalon filter 20. The transmission wavelength scans over the wavelength range decided by the designed described in the following paragraphs when the signal beam incident angle changes. A second detector 32 is positioned to receive a single wavelength reference beam that travels through calibration etalon 21. The transmission of the reference etalon will scan across different order of the single-wavelength reference source, which appears as sequential intensity change between minimum and maximum intensity on the detector 32.

The transmission wavelength of the Fabry-Perot etalon 20 is decided by its angular position. It is important to calibrate the angular position of Fabry-Perot etalon 20. This can be achieved by passing a single-wavelength reference beam through calibration etalon 21 and monitoring the transmission intensity change on detector 32. Because the FSR of calibration etalon 21 is small, when substrate 26 rotates, second detector 32 sees the transmission power peaks from different interference orders. The relationship between the signal channel measurement from first detector 30 and the second detector 32 can be established for calibration purpose, as described below.

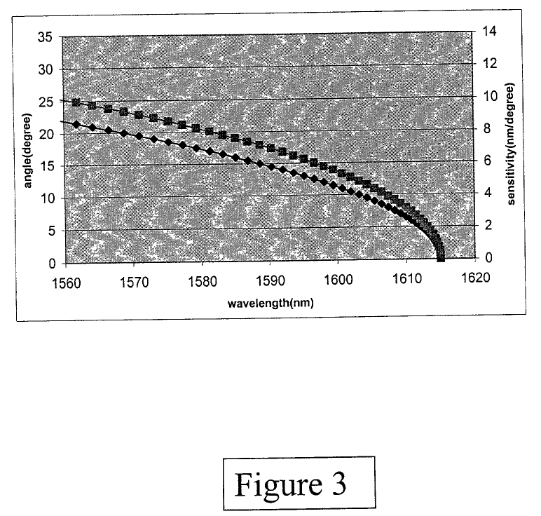

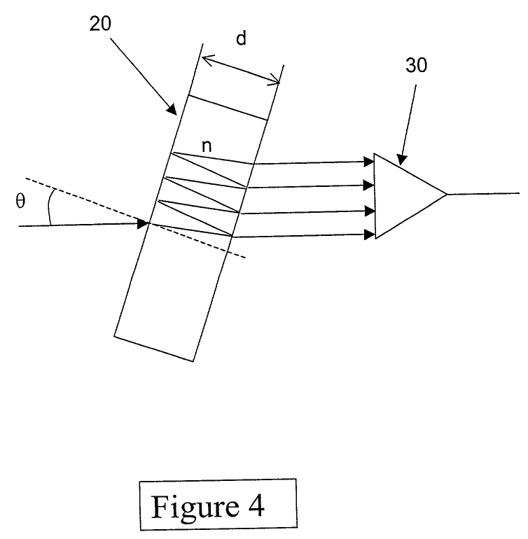

In general, a Fabry-Perot etalon can be characterized by Free Spectral Range(FSR), Finesse F and spectral resolution. The relationship of them can be written as

$$Free Spectral Range FSR = \frac{{λ}_{norm}^{2}}{2 nd} , \\ Etalon Thickness d = \frac{{λ}_{norm}^{2}}{2 nFSR}$$

$$Normal Transmitted Wavelength {λ}_{norm} = \frac{2 nd}{m}$$

$$Transmitted Wavelength at θ λ = \frac{2 nd}{m} \sqrt{1 - {( \frac{sin θ}{n} )}^{2}}$$

$$F = FSR / Δ λ = \frac{π \sqrt{R}}{1 - R}$$

where n is the refractive index of the solid etalon, m the transmission order, d the etalon thickness, λₙₒᵣₘ the normal incident transmission wavelength, and R the reflectance of the etalon surfaces. For example, if we want to cover the wavelength range of 1560 nm˜1615 nm, we need a FSR of 55 nm. Assume the refractive index is 1.44 for fused silica solid etalon. Then we can calculate

$${λ}_{min} = 1560 nm , {λ}_{norm} = 1615 nm , FSR = 55 nm , n = 1.44$$

$$d = \frac{{λ}_{norm}^{2}}{2 nFSR} = 16.46 μm , m = \frac{2 nd}{{λ}_{norm}} ≅ 29$$

$${θ}_{max} = {cos}^{- 1} ( \frac{{λ}_{min}}{{λ}_{norm}} ) = 21.88 °$$

where θₘₐₓ is the maximum angle to tune to get the minimum transmission wavelength of 1560 nm. The transmission wavelength vs. rotation angle and the sensitivity of the wavelength change over angle are shown in FIG. 3 for the example above. An exaggerated drawing of the angle-tuned Fabry-Perot etalon is shown in FIG. 4.

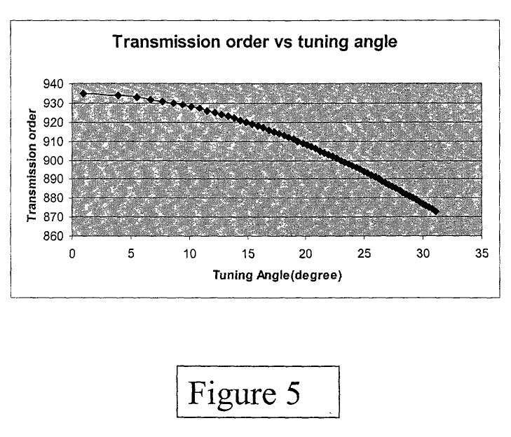

As illustrated in FIG. 2, rotation of Fabry-Perot etalon 20, about a longitudinal axis 34 of substrate 25, provides a real time calibration in response to a relationship of an angle of angle-tuned solid Fabry-Perot etalon filter member 18 and a transmission order of the calibration reference etalon 21. With the same theory and formulas described above, the relationship of peak transmission order of the calibration etalon 21 vs. rotation angle can be calculated, for example, with assumption that reference etalon thickness of 0.5 mm and reference wavelength 0 f 1540 nm, as shown in FIG. 5.

A rotational driver 35 is coupled to angle-tuned solid Fabry-Perot etalon filter member 18. Suitable rotational drivers 35 include but are not limited to, a motor, a galvanometer with corresponding electronic control circuits, and the like.

In one embodiment, Fabry-Perot etalon 20 is a solid and has a thickness calculated based on the requirement that the FSR should be larger than the interested wavelength range. Etalon 20 has a first surface 26 between itself and air, and a second surface 24, between itself and a half of substrate 25. Both surfaces, 24 and 26, are coated with high-reflective (HR) coating. The same half of substrate 25 also has an opposing second surface 28 to the air, which is coated with anti-reflective coating.

The reference etalon 21 is formed by coating both surfaces 42 and 44, of another half of substrate 25, as illustrated in FIGS. 1 and 2.

A first collimator 46 can be coupled to signal input fiber 16 and be in a position that is between tap 14 and Fabry-Perot etalon filter member 18. Also included is a second collimator 48 that is coupled to the reference input and is positioned between a reference source 50 and Fabry-Perot etalon filter member 21. The purpose of collimators is to align the beams to the etalons and the detectors.

In the embodiment where reference source 50 is a single-wavelength reference source, the transmission power of calibration etalon 21 is changed iteratively from maximum to minimum when substrate 25 rotates. Transmission peaks from different order are seen by detector 32. The relationship of transmitted peak order vs. rotation angle is shown in FIG. 5.

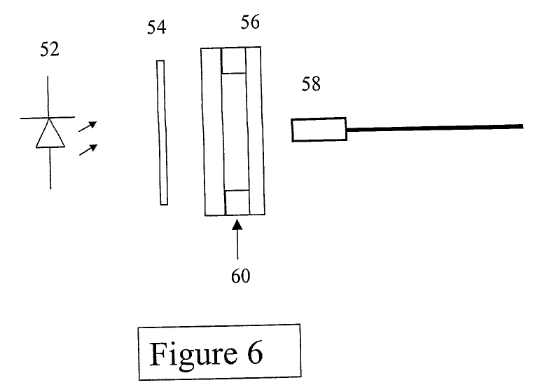

Preferably, reference source 50 is wavelength-stabilized. In one embodiment, illustrated in FIG. 6, reference source 50 is a low-cost LED 52, combined with a band-pass filter 54, a fixed thermal etalon 56 and a collimator 58 to couple light to the fiber. The bandwidth of band filter 54 can be smaller than the FSR of reference Fabry-Perot etalon 56.

In one embodiment, fixed etalon 56 is an a thermal etalon with the use of ultra-low thermal expansion material as spacer 60 of the fixed air-gap etalon. In this instance, a thermal fixed Fabry-Perot etalon 60 can include a low thermal extension material spacer that is optically contacted between two high reflective surfaces.

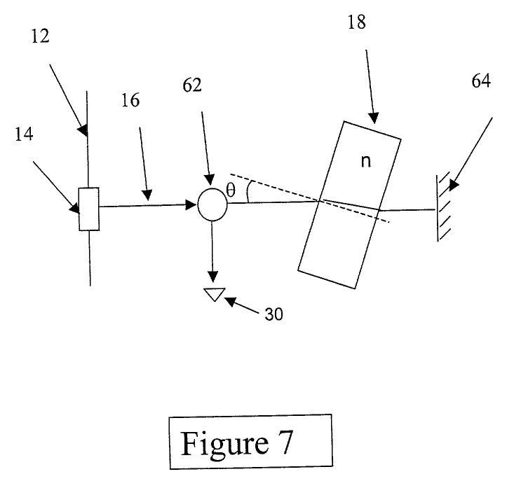

Another embodiment of monitor apparatus 10 is illustrated in FIG. 7. In this embodiment, Fabry-Perot etalon filter member 18 of FIGS. 1 and 2 is utilized and positioned between a circulator 62 and a total reflective mirror 64. An optical retro-reflector can also be used to replace mirror 64. In this embodiment, detector 30 is replaced by total reflective mirror 64, and moved to the output port of the circulator 62. The signal passes through Fabry-Perot etalon 20 twice and returns to the output port of circulator 62, where detector 30 picks up the signal. The FIG. 7 embodiment is particularly suitable for measurement when the signal power is high enough and higher resolution is required.

With monitor apparatus 10 of the present invention, (i) there is no cavity length change and, therefore, no need to keep axial movement accuracy, (ii) low component cost is achieved because of the use of a fixed coating deposited etalon cavity, (iii) high resolution is achieved, particularly when the use of the double pass embodiment, (iv) displacement of the beam minimizes signal loss due to the use of a large-area detector instead of an output fiber, (v) mechanical issues are reduced because rotational movement is used instead of linear translation movement, (vi) high accuracy can be achieved due to a real-time in-line calibration, and (vii) a switch is not used permitting scan speed to be high and calibration cost low, and a single component is used for both measurement and calibration Fabry-Perot etalons.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A monitor apparatus configured to monitor optical performance in an optical fiber or an optical network, comprising:
a tap coupled to the optical fiber or optical network, and a signal input fiber;
an angle-tuned solid Fabry-Perot etalon filter member coupled to the tap, the Fabry-Perot etalon filter member including an angle tuned solid Fabry-Perot etalon coupled to the signal input fiber and a calibration etalon coupled to a reference input fiber, wherein the Fabry-Perot etalon is associated with a first portion of a substrate and the calibration etalon is associated with a second portion of the substrate;
a first detector positioned to receive a signal wavelength that travels through the angle tuned solid Fabry-Perot etalon filter, and
a second detector positioned to receive a single wavelength reference that travels through the calibration etalon, wherein rotation of the angle-tuned solid Fabry-Perot etalon filter member about a longitudinal axis of the substrate provides a real time calibration by in response to a relationship of an angle of the angle-tuned solid Fabry-Perot etalon filter member and a transmission order of the reference calibration etalon.

2. The apparatus of claim 1, wherein the Fabry-Perot etalon is a solid and has a thickness calculated based on the required FSR, which is larger than the interested wavelength range by a margin, for example 15%.

3. The apparatus of claim 1, wherein the substrate has a first surface and an opposing second surface.

4. The apparatus of claim 3, wherein the signal Fabry-Perot etalon is coupled to the first surface of a first portion of the substrate.

5. The apparatus of claim 4, further comprising:
a first HR coating on a first surface of the Fabry-Perot etalon and a second HR coating on a second surface of the Fabry-Perot etalon.

6. The apparatus of claim 5, wherein the second HR coating is formed on the first surface of the first portion of the substrate.

7. The apparatus of claim 5, wherein the second surface of the first portion of the substrate includes an AR coating.

8. The apparatus of claim 3, further comprising:
a first HR coating on the first surface of the second portion of the substrate, and a second HR coating on the second surface of the second portion of the substrate.

9. The apparatus of claim 8, wherein the calibration etalon is formed between the first and second HR coatings that are on the second portion of the substrate.

10. The apparatus of claim 8, wherein the calibration etalon is included in the second portion of the substrate.

11. The apparatus of claim 1, further comprising:
a first collimator coupled to signal input fiber and positioned between the tap and the Fabry-Perot etalon filter member; and
a second collimator coupled to the reference input and positioned between a reference source and the Fabry-Perot etalon filter member.

12. The apparatus of claim 1, further comprising:
a rotational driver coupled to the angle-tuned solid Fabry-Perot etalon filter member.

13. The apparatus of claim 12, wherein the rotational driver is a motor or a galvanometer with corresponding electronic control circuits.

14. The apparatus of claim 1, further comprising:
a single-wavelength reference source coupled to the reference input fiber.

15. The apparatus of claim 14, wherein the single wavelength reference source is selected from an LED, an a thermal fixed Fabry-Perot etalon and an optical filter that has passband bandwidth smaller than the reference Fabry-Perot etalon.

16. The apparatus of claim 15, wherein the a thermal fixed Fabry-Perot etalon includes a low thermal extension material spacer optically contacted between two high reflective surfaces.

17. A monitor apparatus configured to monitor optical performance in an optical fiber or an optical network, comprising:
a tap coupled to the optical fiber or optical network, and a signal input fiber;
an angle-tuned solid Fabry-Perot etalon filter member coupled to the tap, the Fabry-Perot etalon filter member including an angle tuned solid Fabry-Perot etalon coupled to the signal input fiber and a calibration etalon coupled to a reference input fiber, wherein the Fabry-Perot etalon is associated with a first portion of a substrate and the calibration etalon is associated with a second portion of the substrate;
a first detector positioned to receive a signal wavelength that travels through the angle tuned solid Fabry-Perot etalon filter, wherein rotation of the angle-tuned solid Fabry-Perot etalon filter member about a longitudinal axis of the substrate provides a real time calibration by in response to a relationship of an angle of the angle-tuned solid Fabry-Perot etalon filter member and a transmission order of the reference etalon.
a total reflection mirror that produces a reflected signal beam from the input signal, the reflecting signal traveling back through the angle-tuned solid Fabry-Perot etalon filter member, the angle tuned solid Fabry-Perot etalon filter member being positioned between the tap and the total reflection mirror; and
a circulator coupled to the tap and the an angle-tuned solid Fabry-Perot etalon filter member, the circulator being positioned to receive the reflected signal beam,
a first detector positioned after the output port of the circulator to detect the signal picked up by the circulator,
a second detector positioned to receive the reference signal going through the reference etalon.

18. The apparatus of claim 17, wherein the Fabry-Perot etalon is a solid and has a thickness calculated based on the required FSR, which is larger than the interested wavelength range by a margin, for example 15%.

19. The apparatus of claim 17, wherein the substrate has a first surface and an opposing second surface.

20. The apparatus of claim 17, wherein the Fabry-Perot etalon is coupled to the first surface of a first portion of the substrate.

21. The apparatus of claim 20, further comprising:
a first HR coating on a first surface of the Fabry-Perot etalon and a second HR coating on a second surface of the Fabry-Perot etalon.

22. The apparatus of claim 21, wherein the second HR coating is formed on the first surface of the first portion of the substrate.

23. The apparatus of claim 21, wherein the second surface of the first portion of the substrate includes an AR coating.

24. The apparatus of claim 17, further comprising:
a first HR coating on the first surface of the second portion of the substrate, and a second HR coating on the second surface of the second portion of the substrate.

25. The apparatus of claim 24, wherein the calibration etalon is positioned between the first and second HR coatings that are on the second portion of the substrate.

26. The apparatus of claim 24, wherein the calibration etalon is included in the second portion of the substrate.

27. The apparatus of claim 17, further comprising:
a first collimator coupled to signal input fiber and positioned between the tap and the Fabry-Perot etalon filter member; and
a second collimator coupled to the reference input and positioned between a reference source and the Fabry-Perot etalon filter member.

28. The apparatus of claim 17, further comprising:
a rotational driver coupled to the angle-tuned solid Fabry-Perot etalon filter member.

29. The apparatus of claim 28, wherein the rotational driver is a motor or a galvanometer with corresponding electronic control circuits.

30. The apparatus of claim 17, further comprising:
a single-wavelength reference source coupled to the coupled to a reference input fiber.

31. The apparatus of claim 30, wherein the single wavelength reference source is selected from an LED, an a thermal fixed Fabry-Perot etalon and an optical filter that has passband bandwidth smaller than the FSR of the solid Fabry-Perot etalon.

32. The apparatus of claim 31, wherein the a thermal fixed Fabry-Perot etalon includes a low thermal extension material spacer optically contacted between two high reflective surfaces.
